(19) United States
(12) Patent Application Publication
(10) Pub. No.: US 2012/0074624 A1
(43) Pub. Date: Mar. 29, 2012

(54) FURNACE FURNITURE

(75) Inventor: Michael S. Wood, Longboat Key, FL (US)

(73) Assignees: Castalloy, Inc., Cleveland, OH (US); Alcon Industries, Inc., Cleveland, OH (US)

(21) Appl. No.: 13/229,686

(22) Filed: Sep. 10, 2011

Related U.S. Application Data
(60) Provisional application No. 61/381,649, filed on Sep. 10, 2010.

(51) Int. Cl. F27D 5/00; B23P 11/00

(52) U.S. Cl. 266/274; 29/525.01

(57) ABSTRACT

Furnace furniture (10) comprising a modular assembly of cast link parts (20) arrayed in rows and cast connector parts (30) mechanically connecting the cast link parts (20) together. The metal for the cast parts can be formulated to accommodate particular thermal-treatment circumstances.

And the modular assembly method allows the fabrication of many furnace-furniture designs from a standard inventory of cast metal parts.

### RELATED APPLICATION

This application claims priority under 35 U.S.C. §119(e) to U.S. Patent Application No. 61/381,649 filed on Sep. 10, 2010. The entire disclosure of this provisional patent application is hereby incorporated by reference. To the extent that any inconsistencies exist between the provisional patent application and the present disclosure, the latter governs for the purposes of resolving indefiniteness issues.

### BACKGROUND

Furnace furniture is used to hold, position, or otherwise support workpieces while they are subjected to thermal treatment steps. The workpieces, and thus also the furnace furniture, have typically and traditionally encountered intense temperature swings during treatment cycles. And the relatively recent advents of vacuum chambers and gas quenching steps have further exaggerated such swings, as well as reducing cycle times.

### SUMMARY

The present invention provides furnace furniture which comprises an assembly of cast metal parts mechanically connected together (e.g., with threaded cast connector parts). When compared to, for example, furnace-furniture assemblies comprising wrought parts, the furniture of the present invention needs to make much few thermal-expansion concessions, resulting in diminished distortion and deterioration. It can be made rigid, dimensionally stable, and still relatively lightweight, whereby the overall workpiece process is blessed with enhanced robotic compatibility and improved energy efficiency. And with cast parts, the metal can be formulated to accommodate particular thermal-treatment circumstances. Moreover, the associated assembly method allows the fabrication of many furnace-furniture designs from a standard inventory of cast metal parts.

### DRAWINGS

FIGS. 1A-1B, 2A-2B, 3A-3B, 4A-4B, 5A-5B, 6A-6B, and 7A-7B show some of the possible forms of the furnace furniture 10.

FIGS. 8A-8B, 9A-9B, 10A-10B, 11A-11B, 12A-12B, 13, 14, 15, and 16 show cast link parts 20.

FIGS. 17A-17B and 18A-18B show cast connector parts 30.

FIGS. 19A-19C, 20A-20C, 21, 22, and 23 show cast rail parts 40.

FIGS. 24A-24B show cast post parts 50.

FIGS. 25A-25B show cast bracket parts 60.

FIG. 26 shows an inventory 70 of cast parts for making the furnace furniture.

### DESCRIPTION

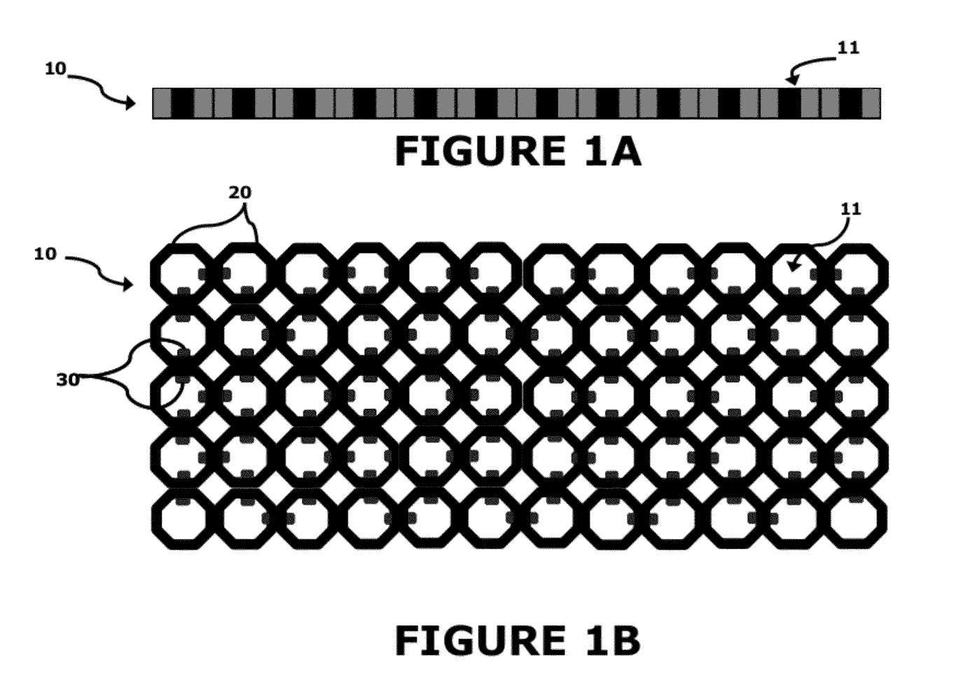

Referring now to the drawings, and initially to FIGS. 1A-1B, 2A-2B, 3A-3B, 4A-4B, 5A-5B, 6A-6B, and 7A-7B, various forms of furnace furniture 10 are shown. The furnace furniture 10 includes a modular assembly of cast parts which can include cast link parts 20, cast connector parts 30, and other cast parts, such as cast rail parts 40, cast post parts 50, and/or cast bracket parts 60.

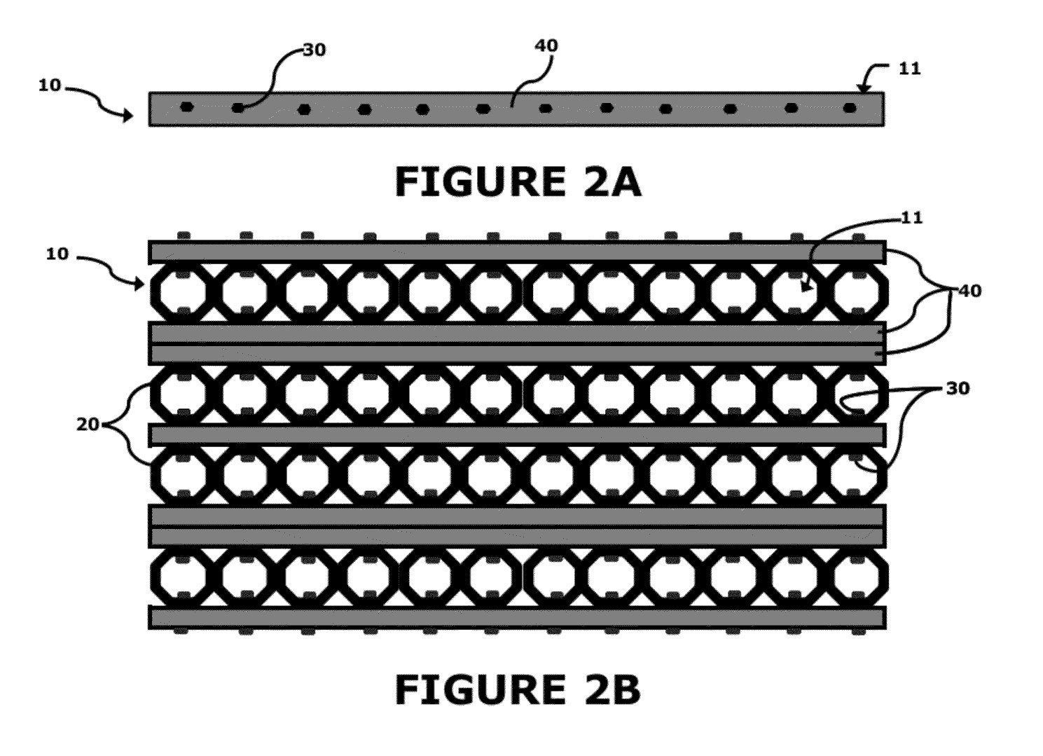

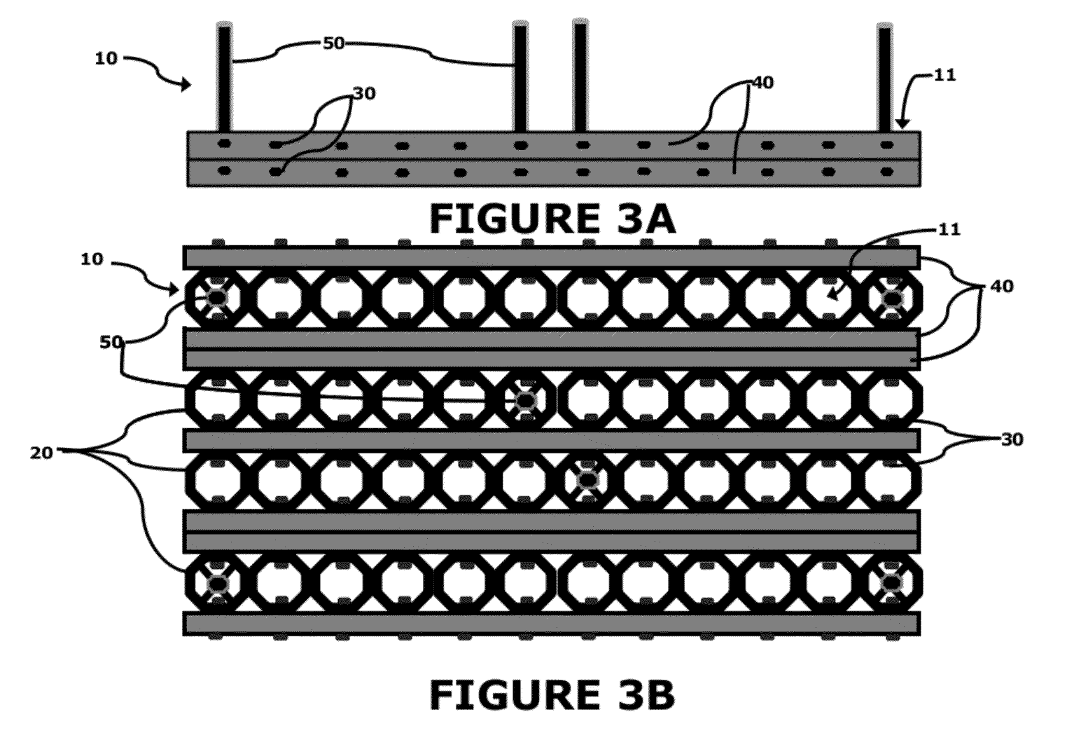

The modular assembly method allows the fabrication of many furnace-furniture designs from the same cast metal parts. For example, the furniture 10 can take the form of a tray comprising a floor 11 on which workpieces can be placed. (FIGS. 1A-1B, 2A-2B, 3A-3B, 4A-4B, and 5A-5B.) The floor 11 can comprise a single-level array (FIGS. 1A-1B and 2A-2B) or it can comprise a multiple-level array (FIGS. 3A-3B, 4A-4B, and 5A-5B).

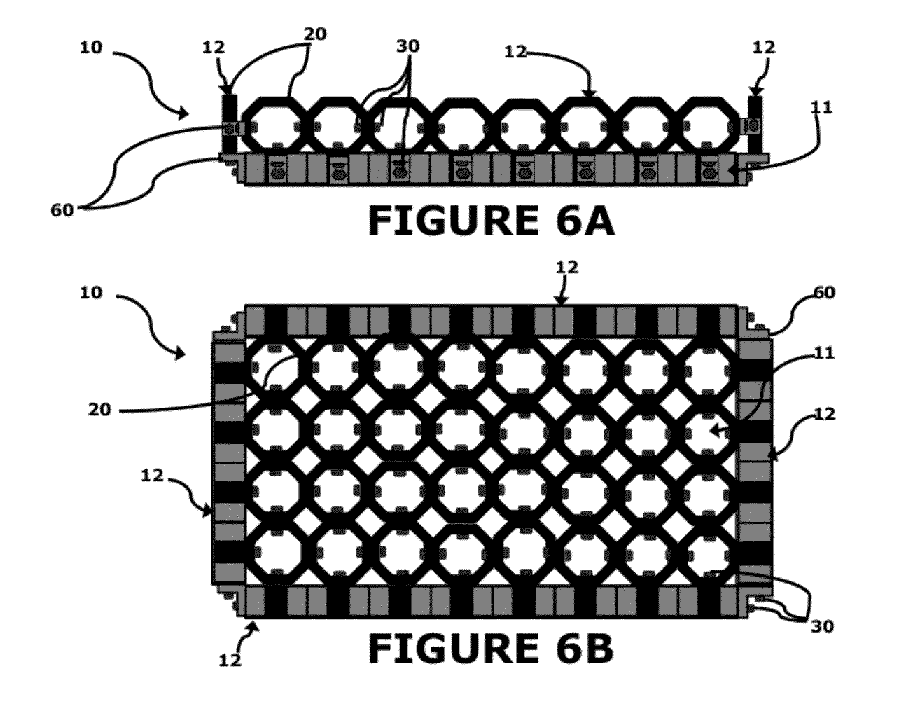

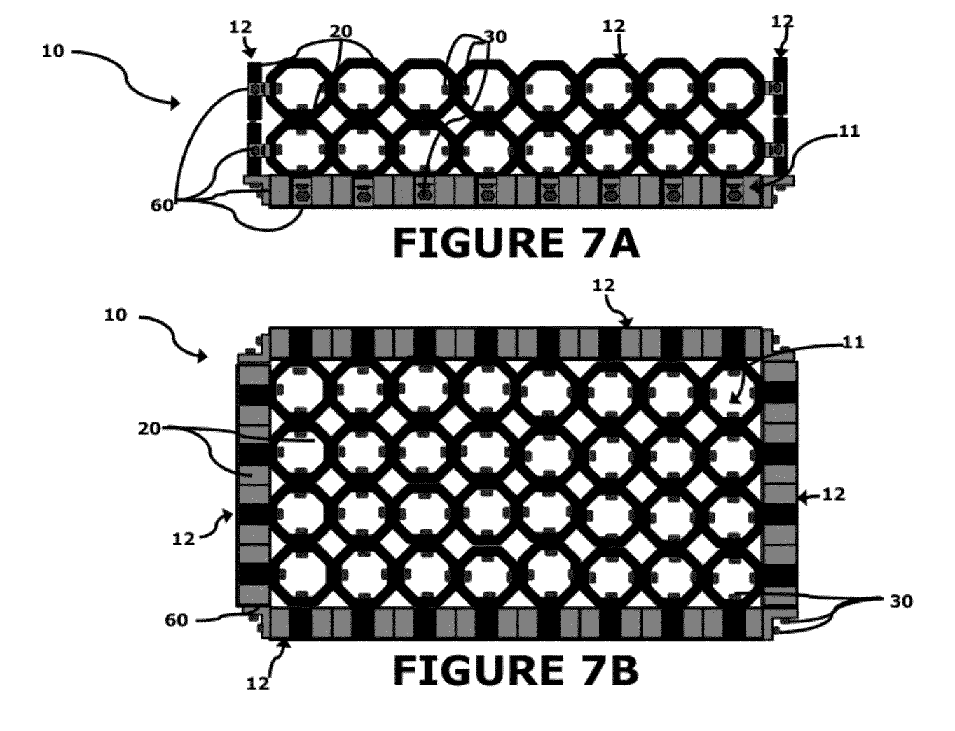

The furniture 10 can also take the form of a basket in which workpieces can be placed. (FIGS. 6A-6B and 7A-7B.) The basket can comprise a floor 11 and sides 12 extending upward from the edges thereof. The sides 12 can comprise a single row or plural rows of the cast link parts 20 to tailor them to a desired height.

The furnace furniture 10 can be characterized by an absence of wrought parts. By constructing the assembly only from cast parts, issues with distortion and deterioration are dramatically decreased. And the furniture 10 can be fabricated at about the same cost, and often more economically, than an analogous assembly comprising both cast and wrought parts.

The cast metal parts can be made from iron-based heat resistant alloys and/or iron-based corrosion resistant alloys. At least some of the cast metal parts can be made from the same alloy and/or at least some of the cast metal parts can be made from different alloys. For example, all of the cast link parts 20 can be made from the same alloy, all of the cast connector parts 30 can be made from the same alloy, and/or all of the cast rail parts 40 can be made from the same alloy, these alloys being the same or different.

Alternatively, the cast parts can be made from different alloys, so as to customize the furniture 10 for its intended thermal conditions and/or load requirements. For an example, the cast link parts 20 in a load-supporting region of the furniture 10 may be made of more corrosion-resistant alloy than surrounding link parts 20.

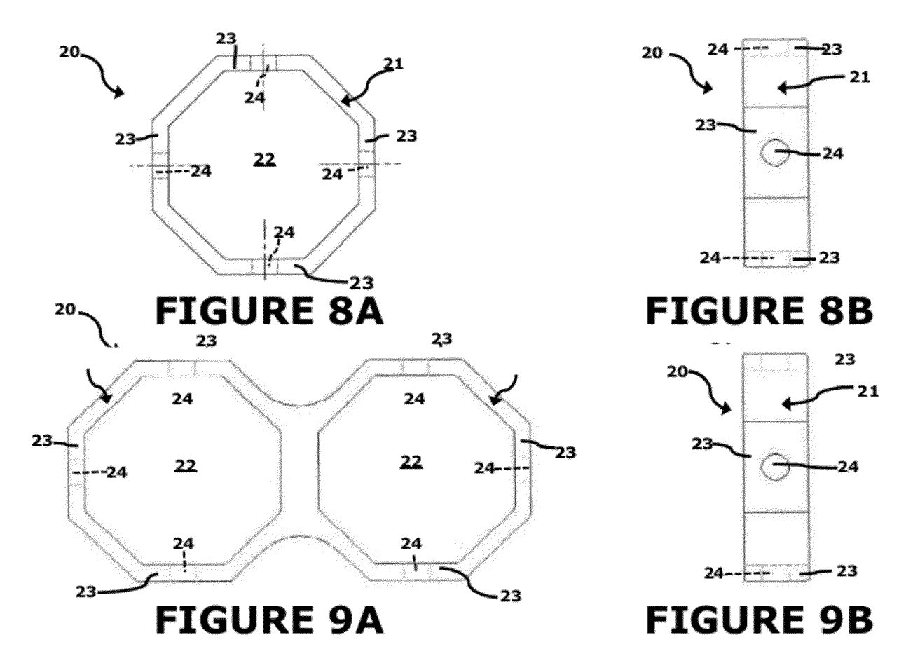

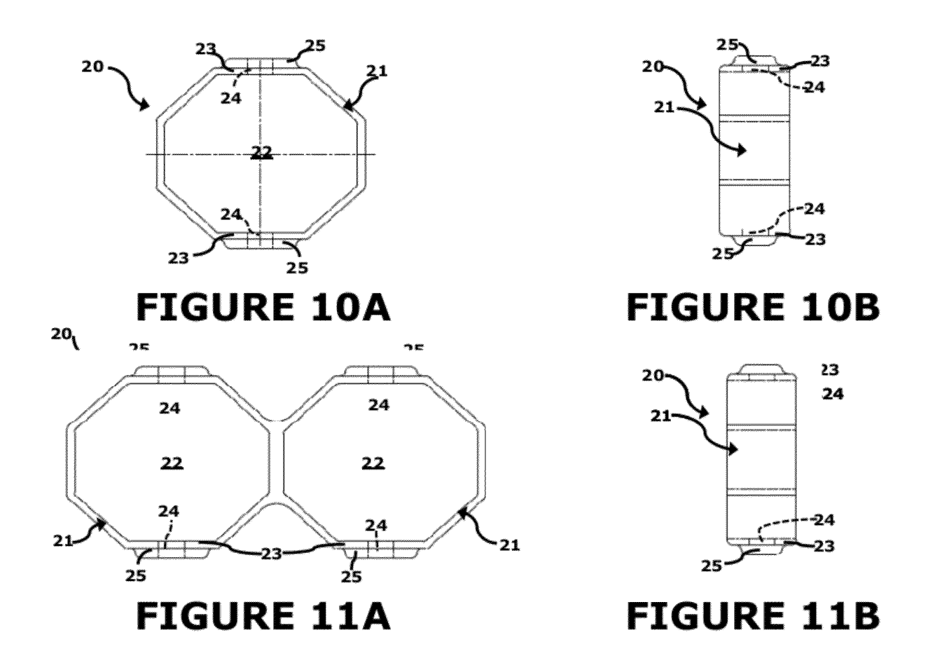

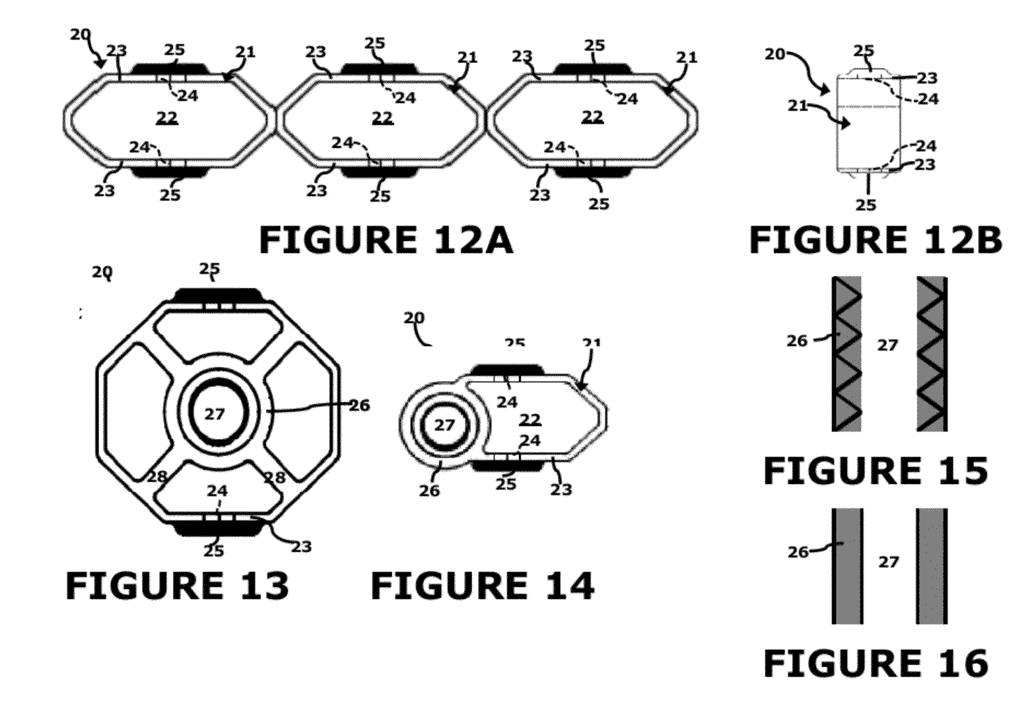

Referring to FIGS. 8A-8B, 9A-9B, 10A-10B, 11A-11B, 12A-12B, 13, 14, 15 and 16, some possible forms of the cast link parts 20 are shown. The cast link parts 20 each include a wall structure 21 surrounding a compartment 22. The wall structures 21 can have any suitable shape, such as the illustrated polygonal (e.g., octagonal) profile. A cast link part 20 can have a single wall structure 21 surrounding a single compartment 22 (FIGS. 8A-8B and 10A-10B), two wall structures 21 surrounding dual compartments 22 (FIGS. 9A-9B, and 11A-11B), or more wall structures 21 and/or compartments 22 (FIGS. 12A-12B).

At least some of the cast link parts 20 include a lateral wall 23 having an opening 24 extending transversely therethrough for receipt of one of the cast connector parts 30. If the cast link parts 20 are to be used with cast rail parts 40, the openings 24 can be between, within, and/or on platforms 25 (FIGS. 10A-10B, 11A-11B, and 12A-12B). The platforms 25 can prevent rotation and/or provide appropriate spacing relative to the cast rail parts 40.

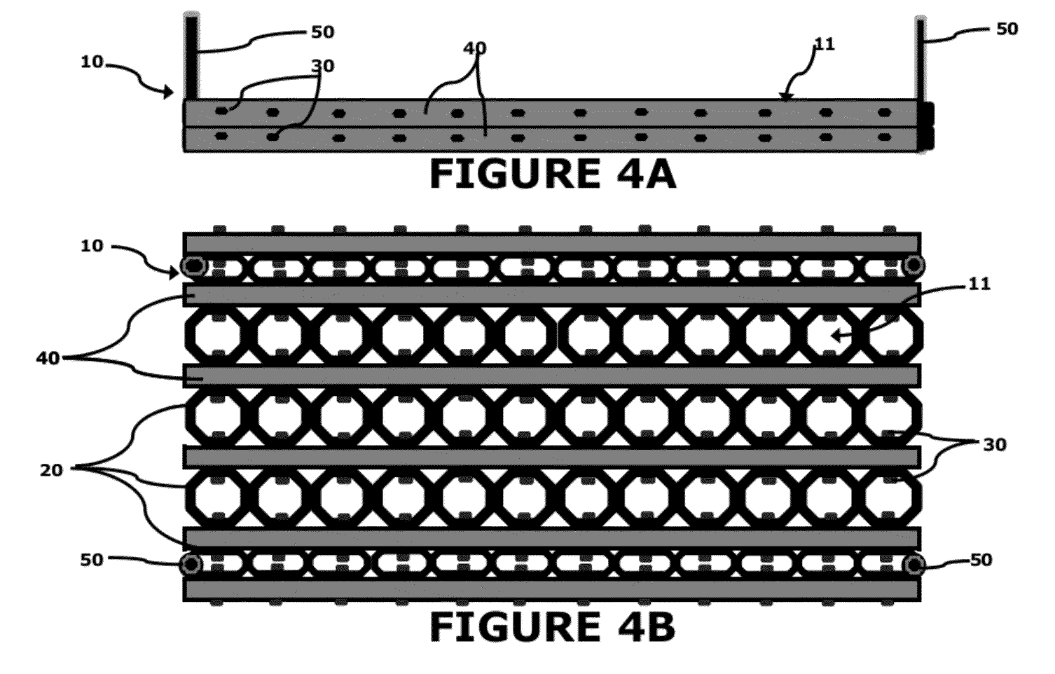

If the cast link parts 20 are to be used with cast post parts 50, such as is shown in FIGS. 3A-3B and 4A-4B, they can comprise a pedestal 26 having a post-receiving channel 27 extending therethrough (FIGS. 13-14). The channels 27 can be threaded (FIG. 15) or unthreaded (FIG. 16) depending upon the post design. The pedestal 26 can be located within the compartment 22 of the wall structure 21 and connected thereto by spokes 28 (FIG. 13). Alternatively, the pedestal 26 can be located adjacent to, but outside of, the compartment 22 of the wall structure 21 (FIG. 14).

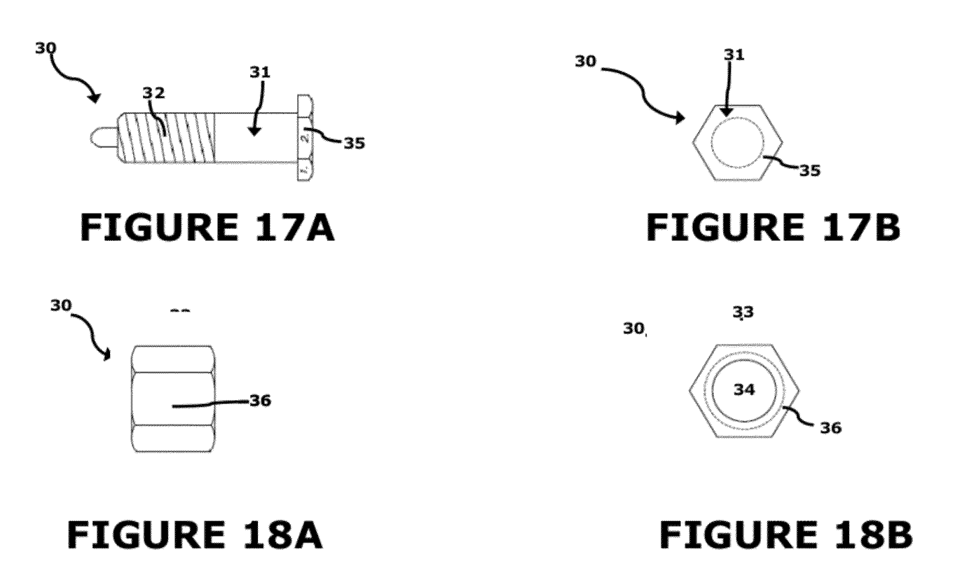

Referring to FIGS. 17A-17B and 18A-18B, the connector parts 30 can comprise bolts 31 with external threads 32 and/or nuts 33 with internal threads 34. The bolt 31 has a hexagonal head 35 and is adapted for insertion through the openings 24 in the cast link parts 20 and/or analogous openings in the cast rail parts 40 (namely openings 44, introduced below). The nut 32 has a hexagonal rim 36 and is adapted to mate with the external threads 32 of a bolt 31.

While the illustrated connector parts 30 comprise mating components, this need not be the case. Bolt-like shafts with external threads could be incorporated into other cast parts (e.g., the link parts 20 and/or the rail parts 30) whereby the connector parts 30 could comprise internally threaded parts 33. Alternatively, internal threads could be integrated into the other cast parts whereby the connector parts could comprise just externally threaded parts 32.

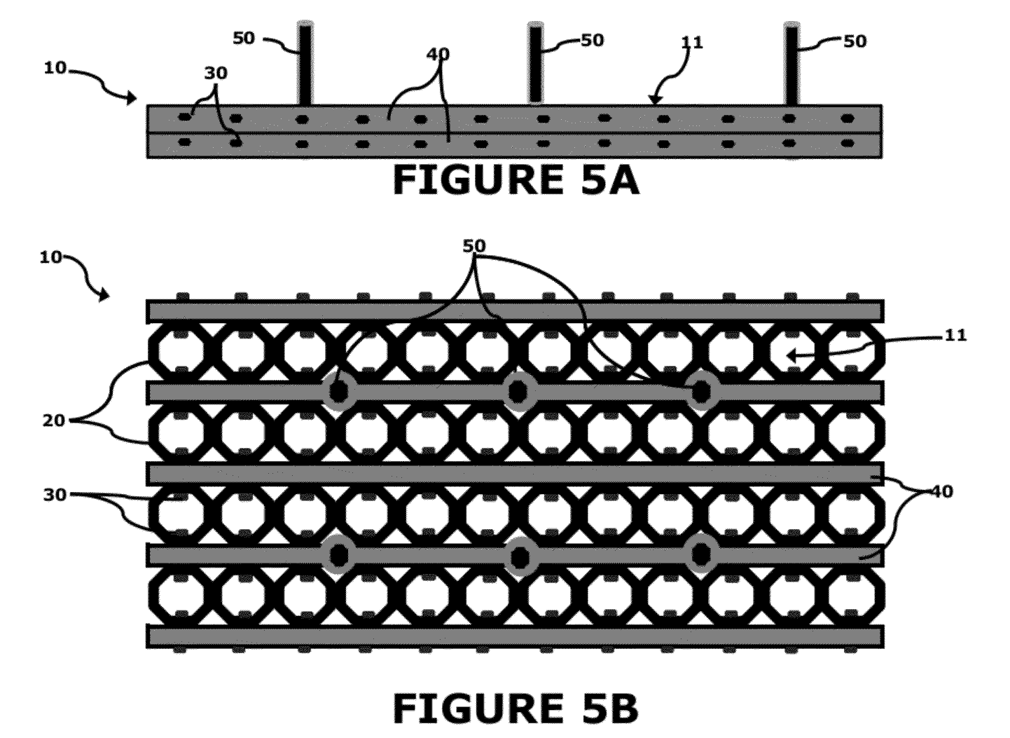

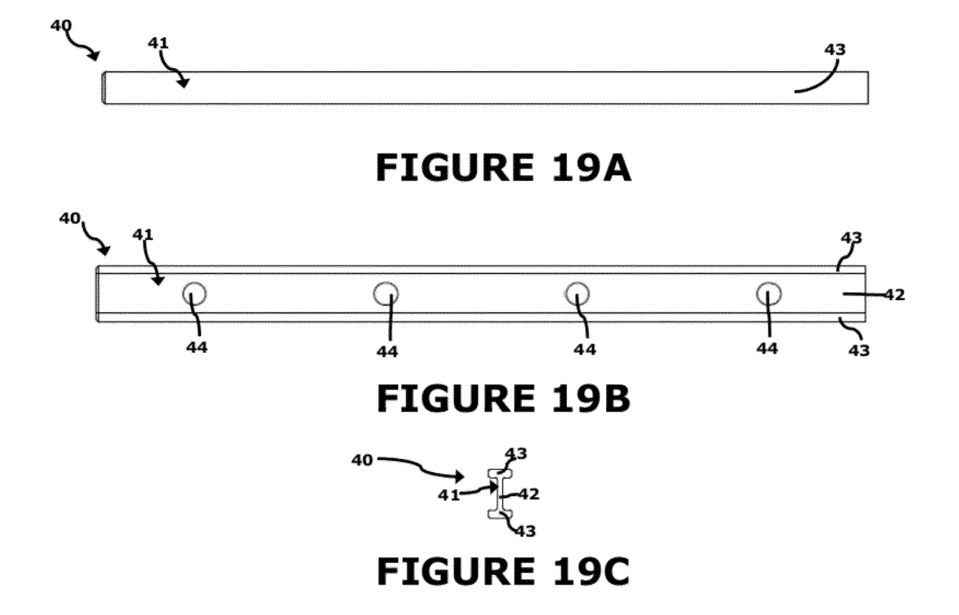

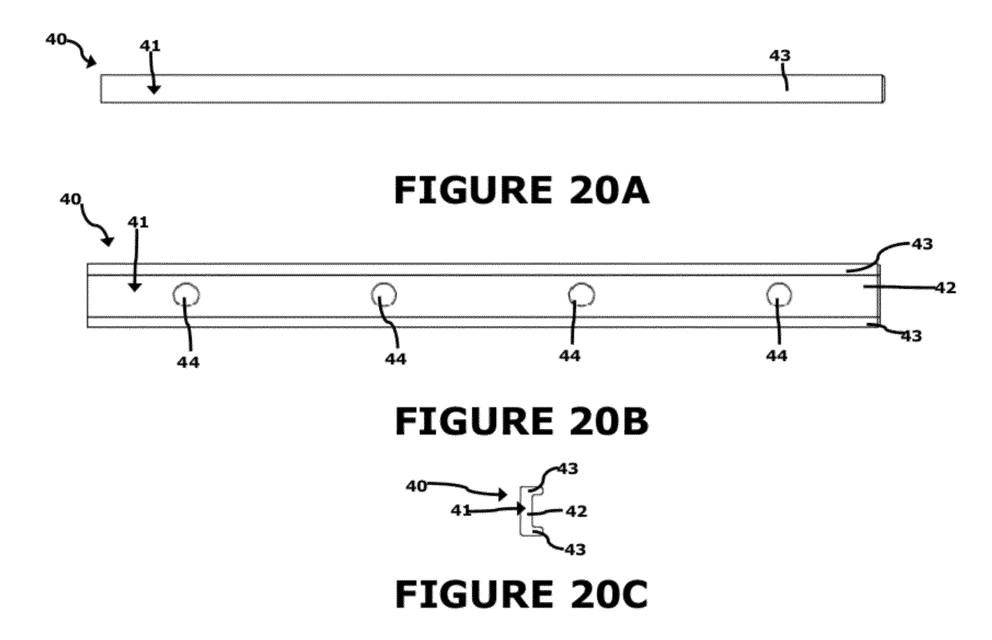

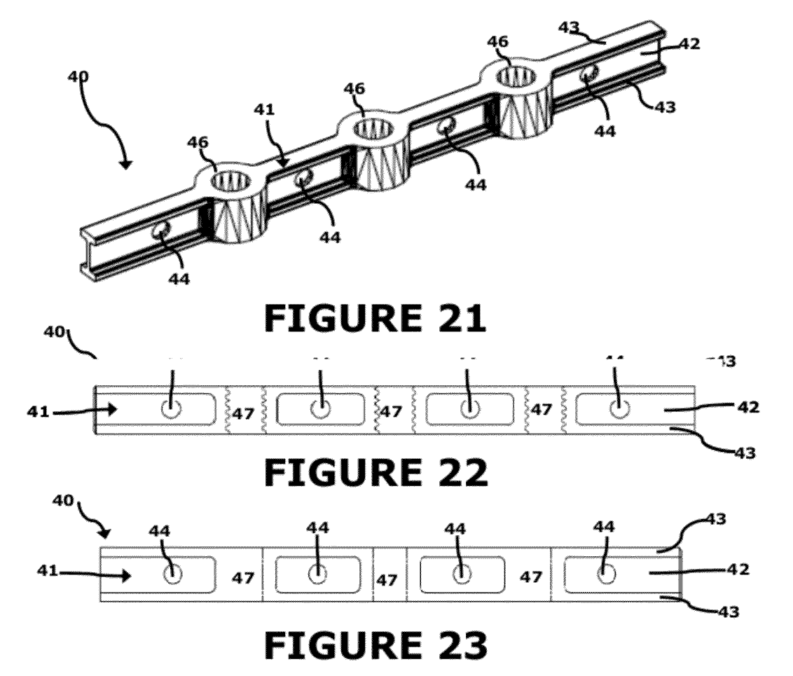

Referring now to FIGS. 19A-19C and 20A-20C, the cast rail parts 40 can each comprise a beam 41. The beam 41 can comprise, for example, a web 42 that resists shear forces and flanges 43 that resist bending moment. Openings 44 are provided in the beams 41 (e.g., the web 42), for receipt of a cast connector part 30. The cast rail parts 40 can comprise I-beams 41 situated, for example, between adjacent link-part rows, and/or U-beams 41 situated, for example, along outside link-part rows. If the rail link parts 40 are to be used with cast post parts 50 such as shown in FIGS. 5A-5B, they can comprise a pedestal 46 having a post-receiving channel 47 extending therethrough (FIG. 21). The channels 47 can be threaded (FIG. 22) or unthreaded (FIG. 23) depending upon the post design.

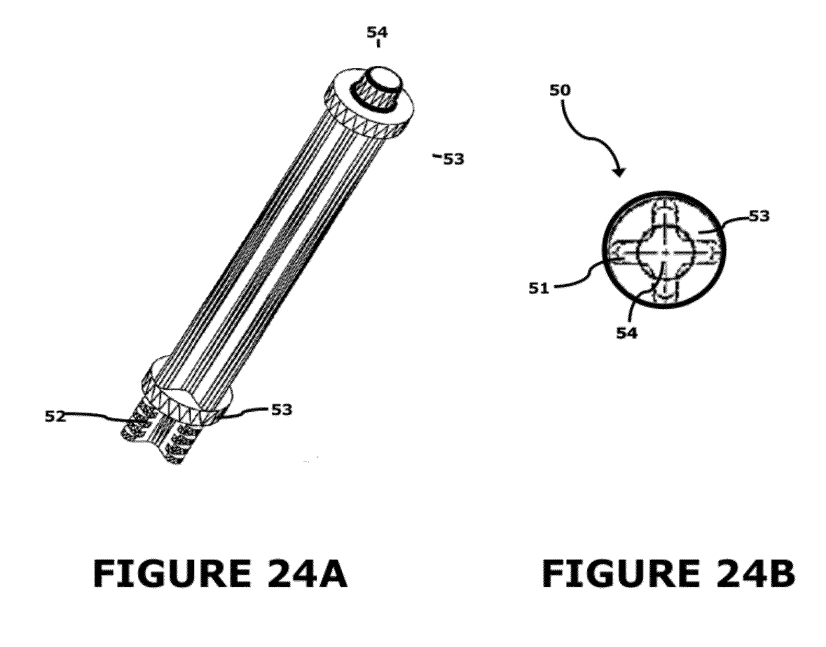

Referring to FIGS. 24A-24B, the cast post parts 50 can each comprise an elongated rod 51 having a suitable shape, such as the illustrated crucible cross section. The lower end portion 52 is adapted for insertion into the channels 27 of the cast link parts 20 and/or the channels 47 of the cast rail parts 40 are shown. Accordingly, this end portion 52 can be threaded or unthreaded. Radial flanges 53 and/or a top cap 54 can also be provided.

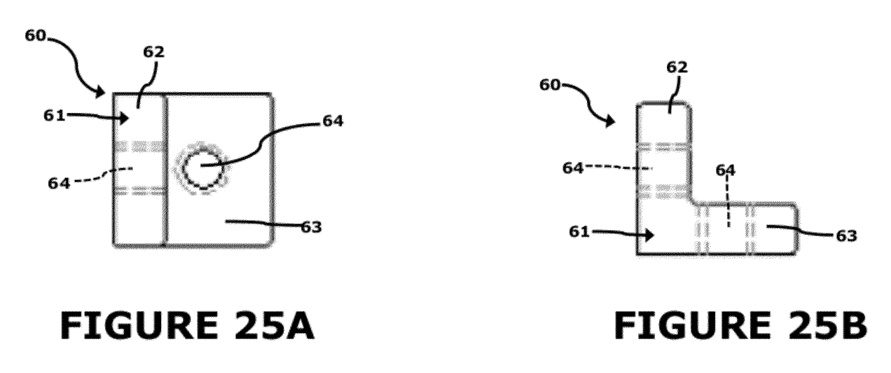

Referring to FIGS. 25A-25B, the cast bracket parts 60 can each comprise a first leg 61 and a second leg 62 extending perpendicular therefrom, either or both of which can have an opening 64 for receipt of a cast connector part 40. As is best seen by referring briefly back to FIG. 1F-1G, the cast bracket parts 60 can be used to construct floor-side corners with basket furniture 10.

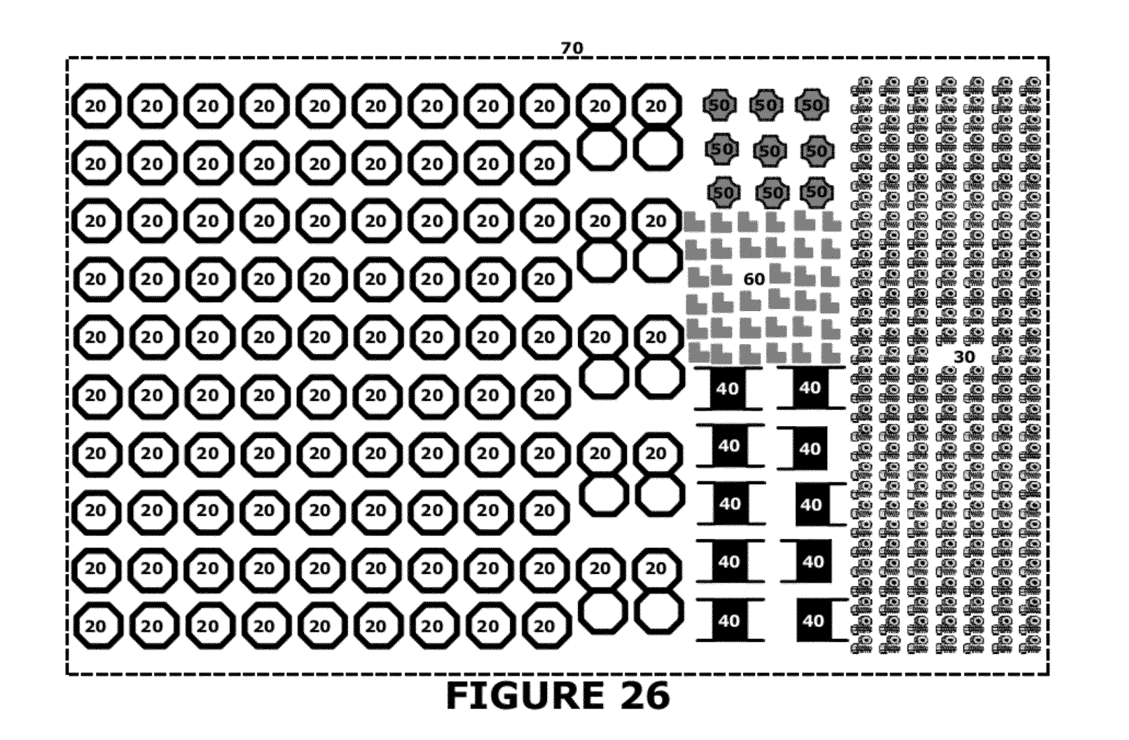

Referring to FIG. 26, an inventory 70 of cast parts for making the furnace furniture 10 is shown. The inventory 70 can comprise, for example, cast link parts 20, cast connector parts 30, cast rail parts 40, cast post parts 50, and/or cast bracket parts 60. In any event, the modularity the cast parts permits fabrication of many furnace-furniture designs from such a standard inventory.

One may now appreciate that the furnace furniture 10 comprises an assembly of cast metal parts mechanically connected together. Although the furniture 10 and the cast parts have been shown and described with respect to certain embodiments, various modifications and additional configurations will be apparent to those skilled in the art.

### REFERENCE NUMBERS

10=furnace furniture
11=floor
12=sides
20=cast link parts
21=wall structure
22=compartment
23=lateral wall
24=connector openings
25=platform
26=pedestal
27=channel
28=spokes
30=cast connector parts
31=bolt
32=external threads
33=nut
34=internal threads
35=hexagonal bolt head
36=hexagonal rim
40=cast rail parts
41=beam
42=web
43=flanges
44=connector openings
46=pedestal
47=channel
50=cast post parts
51=rod
52=end portion
53=radial flanges
54=top cap
60=cast bracket parts
61=leg
62=leg
64=connector openings
70=inventory

1. Furnace furniture comprising an assembly of cast metal parts, said cast metal parts including:
cast link parts arrayed in lateral rows, and
cast connector parts mechanically connecting the cast link parts together.

2. Furnace furniture as set forth in claim 1, characterized by an absence of wrought parts.

3. Furnace furniture as set forth in claim 1, wherein the cast link parts have openings sized for receipt of at least some of the cast connector parts.

4. Furnace furniture as set forth in claim 1, wherein the assembly of cast metal parts forms a tray on which workpieces can be placed.

5. Furnace furniture as set forth in claim 4, wherein the assembly cast metal parts comprises cast rail parts juxtaposed with the lateral rows of cast link parts, the cast rail parts having openings sized for receipt of at least some of the cast connector parts.

6. Furnace furniture as set forth in claim 1, wherein the assembly of cast metal parts forms a basket in which workpieces can be placed.

7. Furnace furniture as set forth in claim 6, wherein the assembly of cast metal parts comprises cast bracket parts having openings sized for receipt of at least some of the cast connector parts.

8. Furnace furniture as set forth in claim 1, wherein the cast metal parts are made from iron-based heat resistant alloys and/or iron-based corrosion resistant alloys.

9. Furnace furniture as set forth in claim 1, wherein the cast link parts each include a wall structure surrounding a compartment.

10. Furnace furniture as set forth in claim 9, wherein the wall structures have a polygonal shape.

11. Furnace furniture as set forth in claim 1, wherein some of the cast link parts have pedestals attached to their wall structure, wherein the assembly of cast metal parts comprises a cast post part, and wherein the cast post part is received in a channel in the pedestal.

12. Furnace furniture as set forth in claim 1, wherein the assembly of cast metal parts comprises cast rail parts, wherein the cast rail parts each comprise a beam having openings for receipt of one of the cast connector parts.

13. Furnace furniture as set forth in claim 12, wherein at least some of the cast rail parts have pedestals attached to the beam, wherein the assembly of cast metal parts comprises a cast post part, and wherein the cast post part is received in a channel in the pedestal.

14. Furnace furniture as set forth in claim 1, wherein the cast connector parts comprise threaded parts.

15. Furnace furniture as set forth in claim 14, wherein the cast connector parts comprise cast connector parts with external threads and/or cast connector parts with internal threads.

16. Furnace furniture as set forth in claim 14, wherein the cast connector parts comprise cast connector parts with external threads and cast connector parts with internal threads that mate therewith.

17. An inventory of cast metal parts for making the furnace furniture set forth in claim 1, said inventory comprising cast link parts and cast connector parts, wherein the cast connector parts are sized for cooperation with openings in the cast link parts.

18. An inventory as set forth in claim 17, further comprising cast rail parts with openings sized for cooperation with the cast connector parts.

19. An inventory as set forth in claim 17, further comprising cast bracket parts with openings sized for cooperation with the cast connector parts.

20. A method of making furnace furniture set forth in claim 1, said method comprising the steps of:
selecting cast link parts, cast connector parts, and other cast parts from an inventory of cast parts;
arraying the cast link parts in lateral rows; and
mechanically connecting the cast link parts with the cast connector parts.
